(19) United States
(12) Patent Application Publication
(10) Pub. No.: US 2019/0348763 A1
(43) Pub. Date: Nov. 14, 2019

(54) PLANAR RF ANTENNA DEVICE WITH 3D CHARACTERISTIC

(71) Applicant: NXP B.V., Eindhoven (NL)

(72) Inventor: HARALD ROBERT, GRAZ (AT)

(21) Appl. No.: 16/405,136

(22) Filed: May 7, 2019

(30) Foreign Application Priority Data
May 14, 2018 (EP) 18172204.2

(51) Int. Cl. H01Q 7/00; H01Q 3/04

(52) U.S. Cl. CPC H01Q 7/00; H01Q 3/04

(57) ABSTRACT

There is described a planar RF transmitter antenna device, comprising a first figure-eight antenna, a second figure-eight antenna, and a loop antenna, wherein the first figure-eight antenna, the second figure-eight antenna and the loop antenna extend in parallel planes, and wherein the orientation of the first figure-eight antenna is perpendicular to the orientation of the second figure-eight antenna. There is also described a method of manufacturing a planar RF transmitter antenna device.

### FIELD OF THE INVENTION

The present invention relates to the field of RF antennas, in particular to a planar RF transmitter antenna device with 3D characteristics. Furthermore, the present invention relates to a method of manufacturing such a planar RF transmitter antenna device.

### ART BACKGROUND

The use of planar RF transmitter antennas in communication links and power harvesting applications is desirable due to the small size of such antennas. However, planar RF transmitter antennas are only able to induce a current in a receiver antenna, if the latter is placed in a plane that is essentially parallel to the planar RF transmitter antenna. A cubic structure comprising three separate planar antennas on non-parallel sides of a cube is more flexible as regards placement of the receiver antenna due to its 3D characteristic but takes up significantly more space than a planar antenna.

Thus, there may be a need for a planar antenna device which is small in size and capable of providing a similar 3D characteristic as the cubic antenna structure discussed above.

### SUMMARY OF THE INVENTION

This need may be met by the subject matter according to the independent claims. Advantageous embodiments of the present invention are set forth in the dependent claims.

According to a first aspect there is provided a planar RF transmitter antenna device. The planar RF transmitter antenna device comprises a first figure-eight antenna, a second figure-eight antenna, and a loop antenna, wherein the first figure-eight antenna, the second figure-eight antenna and the loop antenna extend in parallel planes, and wherein the orientation of the first figure-eight antenna is perpendicular to the orientation of the second figure-eight antenna.

This aspect is based on the idea that the planes of each of two figure-eight antennas are arranged in parallel with the plane of a loop antenna (i.e. essentially in the same plane as the loop antenna, or in parallel planes which are closely spaced e.g. separated by less than 2% or 10% of their size within the plane) and such that their orientations are perpendicular (e.g. such that one figure-eight antenna is standing while the other figure-eight antenna is lying down). Thereby, the figure-eight antennas are capable of generating magnetic fields in perpendicular directions but both parallel to the plane of the loop antenna. The loop antenna is capable of generating a magnetic field in a direction perpendicular to its own plane, i.e. also perpendicular to the respective fields of the figure-eight antennas. Thereby, the planar antenna structure according to this aspect is capable of providing a full 3D characteristic.

In the present context, the term “figure-eight antenna” may particularly denote an antenna structure where conductive material surrounds two separate (disjoint) areas in such a manner that current flows in one direction (e.g. clockwise) around one of the areas and in the opposite direction (e.g. counterclockwise) around the other area.

According to an embodiment, the first figure-eight antenna, the second figure-eight antenna and the loop antenna are symmetrically arranged relative to one another.

In other words, the three antennas are arranged such that the antenna device is symmetric about at least one axis within the planar structure.

According to a further embodiment, the shape and size of the first figure-eight antenna are identical to the shape and size of the second figure-eight antenna.

In other words, the first figure-eight antenna will completely overlap the second figure-eight antenna if they are placed on top of each other.

According to a further embodiment, the first figure-eight antenna is formed by a first continuous conductive path that crosses itself and delimits two disjoint areas such that current flows around the two disjoint areas in opposite directions, and the second figure-eight antenna is formed by a second continuous conductive path that crosses itself and delimits two other disjoint areas such that current flows around the two other disjoint areas in opposite directions.

In this embodiment, each of the first and second figure-eight antennas is formed as a single continuous conductive path that crosses itself at one point and thereby provides the characteristic shape of a figure-eight.

According to a further embodiment, the first figure-eight antenna comprises a first pair of separate conductive paths that are arranged adjacent to each other and delimits two disjoint areas, and the second figure-eight antenna comprises a second pair of separate conductive paths that are arranged adjacent to each other and delimits two other disjoint areas. The device further comprises a first switching circuit adapted to supply current to the first pair of separate conductive paths such that current flows around the two disjoint areas in opposite directions, and a second switching circuit adapted to supply current to the second pair of separate conductive paths such that current flows around the two other disjoint areas in opposite directions.

In this embodiment, each of the first and second figure-eight antennas is formed as a pair of adjacent conductive paths, such that each conductive path delimits an area which is disjoint from (i.e. non-overlapping) the area delimited by the other conductive path. Furthermore, a switching circuit is provided that supplies currents to both conductive paths of a pair in such a way that the current flows around the two disjoint areas in opposite directions, i.e. such that the current flow corresponds to the current flow in a figure-eight antenna formed by a single (crossing) conductive path.

According to a further embodiment, the shape of the two disjoint areas and the shape of the two other disjoint areas are selected from the group consisting of circular, elliptic, triangular, rectangular, square, hexagonal, octagonal, and polygonal.

According to a further embodiment, the loop antenna comprises a single turn having a shape selected from the group consisting of circular, elliptic, triangular, rectangular, square, hexagonal, octagonal, and polygonal.

According to a further embodiment, the loop antenna comprises a plurality of concentric turns, each turn having a shape selected from the group consisting of circular, elliptic, triangular, rectangular, square, hexagonal, octagonal, and polygonal.

Each turn of the plurality of turns may have the same shape as the other turns, as some of the other turns, or as none of the other turns. In the latter case, each turn of the plurality of turns has its own individual shape. For example, the loop antenna may comprise three octagonal turns, e.g. an outer octagonal turn, an intermediate octagonal turn, and an inner octagonal turn. In another example, the loop antenna may comprise three turns of different shapes, e.g. quadratic outer turn, an octagonal intermediate turn, and a circular inner turn.

According to a further embodiment, the device further comprises a set of terminals, and a multiplexer coupled to selectively connect one of the first figure-eight antenna, the second figure-eight antenna, and the loop antenna to the set of terminals.

The terminals constitute a current input of the device and the multiplexer functions to selectively feed the supplied current to one of the three antennas, such that only one of these is generating a magnetic field (in its assigned direction) at a time.

According to a second aspect, there is provided a method of manufacturing a planar RF transmitter antenna device. The method comprises forming a first figure-eight antenna, forming a second figure-eight antenna such that the second figure-eight antenna extends in a plane parallel to the plane of the first figure-eight antenna and such that the orientation of the second figure-eight antenna is perpendicular to the orientation of the first figure-eight antenna, and forming a loop antenna in a plane parallel to the respective planes of the first figure-eight antenna and the second figure-eight antenna.

This aspect essentially provides a method of manufacturing a planar RF transmitter antenna device according to the first aspect or one of the above embodiments.

The steps of the method may be carried out in any suitable order, i.e. the steps do not have to be carried out in the order mentioned above.

Each of the first and second figure-eight antennas and the loop antenna may be formed as traces of conductive material on a substrate or PCB.

It should be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless otherwise indicated, in addition to any combination of features belonging to one type of subject matter also any combination of features relating to different subject matters, in particular a combination of features of the method type claims and features of the apparatus type claims, is also disclosed with this document.

The aspects defined above and further aspects of the present invention will be apparent from the examples of embodiment to be described hereinafter and are explained with reference to the examples of embodiment. The invention will be described in more detail hereinafter with reference to examples of embodiment to which the invention is, however, not limited.

### BRIEF DESCRIPTION OF THE DRAWING

FIGS. 1A to 1D show a planar RF transmitter antenna device in accordance with an embodiment.

FIGS. 2A to 2D show a planar RF transmitter antenna device in accordance with an embodiment.

FIG. 3 shows a figure-eight antenna in accordance with an embodiment.

FIG. 4 shows a figure-eight antenna in accordance with an embodiment.

FIG. 5A shows a figure-eight antenna in accordance with an embodiment.

FIG. 5B shows a figure-eight antenna in accordance with an embodiment.

FIG. 5C shows a loop antenna in accordance with an embodiment.

### DETAILED DESCRIPTION

The illustration in the drawing is schematic. It is noted that in different figures, similar or identical elements are provided with the same reference signs or with reference signs, which differ only within the first digit.

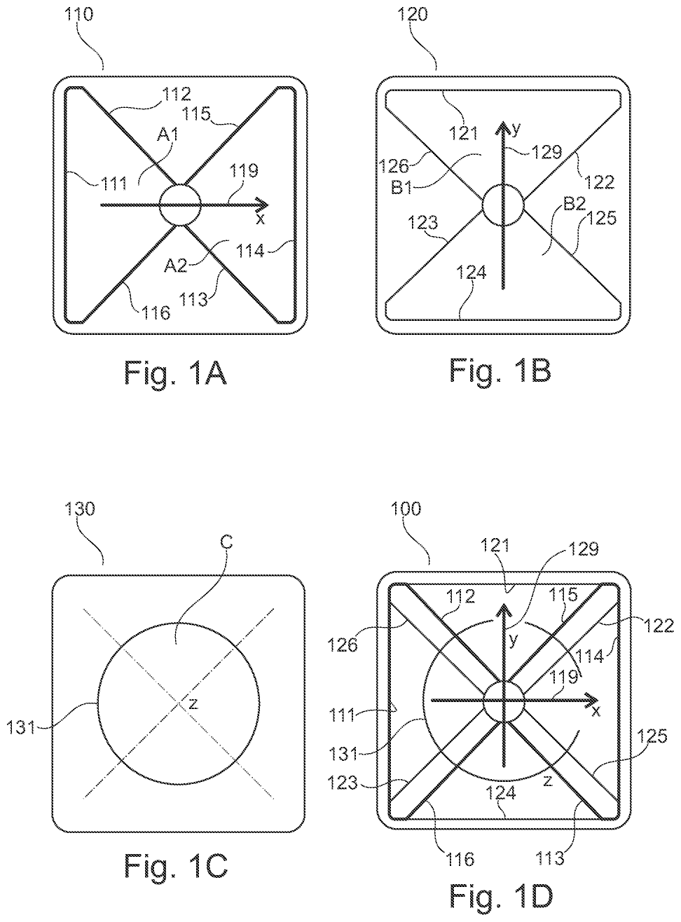

FIG. 1A shows a first figure-eight antenna 110, FIG. 1B shows a second figure-eight antenna 120, FIG. 1C shows a loop antenna 130, and FIG. 1D shows a planar RF transmitter antenna device 100 comprising the first figure-eight antenna 110, the second figure-eight antenna 120, and the loop antenna 130.

The first figure-eight antenna 110 has an hour-glass like shape and comprises conductive segments 111, 112, 113, 114, 115, and 116 forming a single and continuous conductive path between a set of terminals (not shown). The segments 111, 112, and 116 surround or delimit a first area A1 and the segments 113, 114, and 115 surround or delimit a second area A2. The areas A1 and A2 both have substantially triangular shapes. When a current flows through the conductive path consisting of segments 111, 112, 113, 114, 115, and 116 (in that order), it can be seen that the current will flow clockwise around the first area A1 (through segments 111, 112, and 116) whereas the current will flow counterclockwise around the second area A2 (through segments 113, 114, and 115). Thereby, a magnetic field is generated in the direction of arrow 119 (x-axis).

Like the first figure-eight antenna 110, the second figure-eight antenna 120 also has an hour-glass like shape and comprises conductive segments 121, 122, 123, 124, 125, and 126 forming a single and continuous conductive path between a set of terminals (not shown). The segments 121, 122, and 126 surround or delimit a first area B1 and the segments 123, 124, and 125 surround or delimit a second area B2. The areas B1 and B2 both have substantially triangular shapes. When a current flows through the conductive path consisting of segments 121, 122, 123, 124, 125, and 126 (in that order), it can be seen that the current will flow clockwise around the first area B1 (through segments 121, 122, and 126) whereas the current will flow counterclockwise around the second area B2 (through segments 123, 124, and 125). Thereby, a magnetic field is generated in the direction of arrow 129 (y-axis).

The loop antenna 130 comprises a single circular conductive segment (or turn) 131 forming a conductive path between a set of terminals (not shown). The turn 131 surrounds a disc-shaped area C. When a current flows in the loop antenna 130, a magnetic field is generated in a direction perpendicular to the plane of the drawing (z-axis).

The three antennas 110, 120, and 130 are arranged symmetrically and concentrically on top of each other to form the planar RF transmitter antenna device 100 shown in FIG. 1D. As shown, the orientation of the first figure-eight antenna 110 is perpendicular to the orientation of the second figure-eight antenna 120. Thereby, there is no coupling between the figure-eight antennas 110, 120. Accordingly, the planar antenna device 100 shown in FIG. 1D has a 3D characteristic, i.e. it is capable of generating magnetic fields in each of the three individually perpendicular directions corresponding to x-axis 119, y-axis 129 and z-axis. Each of the three antennas 110, 120, and 130 may be connected via a respective coupling capacitor to a common LC-matching circuitry (not shown). Furthermore, a switching circuit (not shown) may be arranged to activate one of the three antennas 110, 120, and 130 at a time (while deactivating the two other antennas, e.g. by shorting them to ground). In other words, the three antennas 110, 120, and 130 are preferably arranged in parallel but only one antenna is active at a time. However, although less preferable, a serial arrangement may also be used.

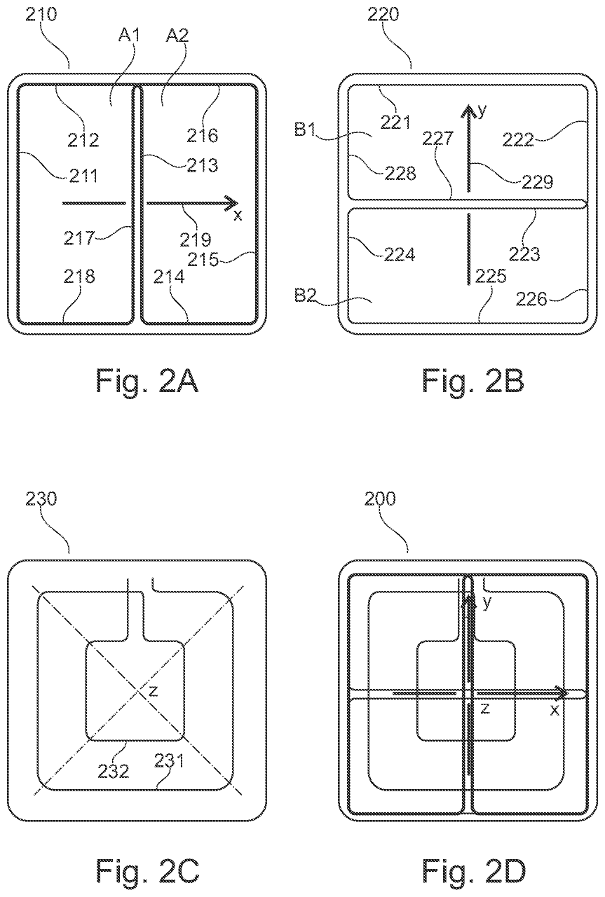

FIGS. 2A to 2D show another embodiment which differs from the embodiment shown in FIG. 1A to 1D in two aspects, namely that the shape of the figure-eight antennas 210, 220 is rectangular (as opposed to triangular) and that the loop antenna 230 comprises two turns (as opposed to a single turn). More specifically, FIG. 2A shows a first figure-eight antenna 210, FIG. 2B shows a second figure-eight antenna 220, FIG. 2C shows a loop antenna 230, and FIG. 1D shows a planar RF transmitter antenna device 200 comprising the first figure-eight antenna 210, the second figure-eight antenna 220, and the loop antenna 230.

The first figure-eight antenna 210 has a rectangular shape and comprises conductive segments 211, 212, 213, 214, 215, 216, 217, and 218 forming a single and continuous conductive path between a set of terminals (not shown). The segments 211, 212, 217, and 218 surround or delimit a first area A1 and the segments 213, 214, 215, and 216 surround or delimit a second area A2. The areas A1 and A2 both have substantially rectangular shapes. When a current flows through the conductive path consisting of segments 211, 212, 213, 214, 215, 216, 217, and 218 (in that order), it can be seen that the current will flow clockwise around the first area A1 (through segments 211, 212, 217, and 218) whereas the current will flow counterclockwise around the second area A2 (through segments 213, 214, 215, and 216). Thereby, a magnetic field is generated in the direction of arrow 219 (x-axis).

Like the first figure-eight antenna 210, the second figure-eight antenna 220 also has a rectangular shape and comprises conductive segments 221, 222, 223, 224, 225, 226, 227, and 228 forming a single and continuous conductive path between a set of terminals (not shown). The segments 221, 222, 227, and 218 surround or delimit a first area B1 and the segments 223, 224, 225, and 226 surround or delimit a second area B2. The areas B1 and B2 both have substantially rectangular shapes. When a current flows through the conductive path consisting of segments 221, 222, 223, 224, 225, 226, 227, and 228 (in that order), it can be seen that the current will flow clockwise around the first area B1 (through segments 221, 222, 227, and 228) whereas the current will flow counterclockwise around the second area B2 (through segments 223, 224, 225, and 226). Thereby, a magnetic field is generated in the direction of arrow 229 (y-axis).

The loop antenna 230 comprises two turns, an outer turn 231 and an inner turn 232, both having a substantially square shape. The two turns 231, 232 form a conductive path between a set of terminals (not shown). When a current flows in the loop antenna 230, a magnetic field is generated in a direction perpendicular to the plane of the drawing (z-axis).

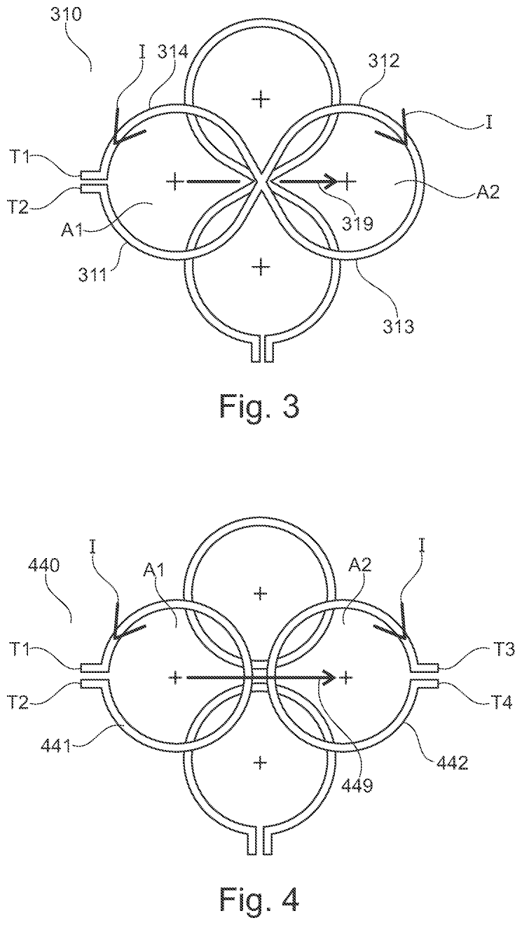

The three antennas 210, 220, and 230 are arranged symmetrically and concentrically on top of each other to form the planar RF transmitter antenna device 200 shown in FIG. 2D. As shown, the orientation of the first figure-eight antenna 210 is perpendicular to the orientation of the second figure-eight antenna 220. Thereby, there is no coupling between the figure-eight antennas 210, 220. Accordingly, the planar antenna device 200 shown in FIG. 2D has a 3D characteristic, i.e. it is capable of generating magnetic fields in each of the three individually perpendicular directions corresponding to x-axis 219, y-axis 229 and z-axis. The rectangular shape of the figure-eight antennas 210, 220 has the advantage that the central conductive paths 213 and 217 respectively 223 and 227 are adjacent to each other along a relative long distance, thereby creating a particularly strong magnetic field in the directions of the x-axis 219 and y-axis 229, respectively. FIG. 3 shows another figure-eight antenna 310 which differs from the figure-eight antennas 110 (FIG. 1A) and 210 (FIG. 2A) in that the areas A1 and A2 are circular (disc-shaped) instead of triangular or rectangular. Furthermore, a set of terminals T1, T2 are shown at the left part of the antenna 310. Also the direction of a current flowing from terminal T2 through rounded conductive segments 311, 312, 313, and 314 to terminal T1 are indicated by arrows I.

FIG. 4 shows another figure-eight antenna structure 440, which comprises two circular conductive segments 441, 442 having respective sets of terminals T1, T2 and T3, T4. The circular conductive segments 441, 442 are arranged close to each other and supplied with current (from a not shown switching circuit) such that the current flowing in the two separate conductive segments 441, 442 are similar to the currents flowing in the figure-eight antenna 310 discussed above in conjunction with FIG. 3. This is illustrated by arrows I and results in generation of a similar magnetic field in the direction of the arrow 449. As the structure 440 comprises no crossings, it is simpler to manufacture and may thus be preferable in some applications.

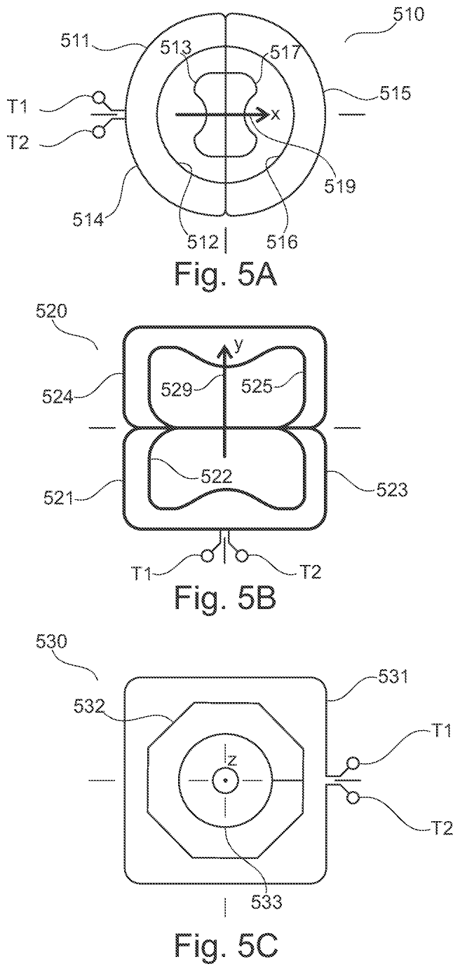

FIGS. 5A to 5C show a further set of two (first and second) figure-eight antennas 510, 520 and a loop antenna 530. The first figure-eight antenna 510 shown in FIG. 5A comprises a three-level nested structure where currents flows in one direction in the left-hand conductive segments 511, 512, 513, and 514, and in the opposite direction in the right-hand conductive segments 515, 516, and 517. The second figure-eight antenna 520 shown in FIG. 5B comprises a two-level nested structure where current flows in one direction in the lower conductive segments 521, 522, and 523, and in the opposite direction in the upper conductive segments 524 and 525. The loop antenna 530 shown in FIG. 5C comprises three concentric turns 531, 532, and 533. The outer turn 531 has a substantially square shape (preferably with rounded corners), the intermediate turn 532 has an octagonal shape, and the inner turn 533 has a circular shape.

In the figure-eight antenna 510, the magnetic field will be very strong in the vicinity of the vertical (as shown in FIG. 5A) region where the loops are adjacent to each other, i.e. a substantially rectangular region with short edges extending in parallel with the arrow 519 and long sides extending perpendicular to the arrow 519. In some applications, it may be desirable to widen the region with high magnetic field strength. This can be achieved by adding some space between the horizontal parts of the segments, e.g. by displacing the segments 512 and 513 a bit towards the left and by displacing the segments 516 and 519 a bit towards the right. Similar adjustments may be made to the second figure-eight antenna 520 shown in FIG. 5B.

It is noted that, unless otherwise indicated, the use of terms such as “upper”, “lower”, “left”, and “right” refers solely to the orientation of the corresponding drawing.

It is noted that the term “comprising” does not exclude other elements or steps and that the use of the articles “a” or “an” does not exclude a plurality. Also elements described in association with different embodiments may be combined. It should also be noted that reference signs in the claims should not be construed as limiting the scope of the claims.

1. A planar RF transmitter antenna device, the planar RF transmitter antenna device comprising
a first figure-eight antenna,
a second figure-eight antenna, and
a loop antenna,
wherein the first figure-eight antenna, the second figure-eight antenna and the loop antenna extend in parallel planes, and wherein the orientation of the first figure-eight antenna is perpendicular to the orientation of the second figure-eight antenna.

2. The device according to claim 1, wherein the first figure-eight antenna, the second figure-eight antenna and the loop antenna are symmetrically arranged relative to one another.

3. The device according to claim 1, wherein the shape and size of the first figure-eight antenna are identical to the shape and size of the second figure-eight antenna.

4. The device according to claim 1, wherein
the first figure-eight antenna is formed by a first continuous conductive path that crosses itself and delimits two disjoint areas such that current flows around the two disjoint areas in opposite directions, and
the second figure-eight antenna is formed by a second continuous conductive path that crosses itself and delimits two other disjoint areas such that current flows around the two other disjoint areas in opposite directions.

5. The device according to claim 1 wherein
the first figure-eight antenna comprises a first pair of separate conductive paths that are arranged adjacent to each other and delimits two disjoint areas, and
the second figure-eight antenna comprises a second pair of separate conductive paths that are arranged adjacent to each other and delimits two other disjoint areas,
the device further comprising
a first switching circuit adapted to supply current to the first pair of separate conductive paths such that current flows around the two disjoint areas in opposite directions, and
a second switching circuit adapted to supply current to the second pair of separate conductive paths such that current flows around the two other disjoint areas in opposite directions.

6. The device according to claim 4, wherein the shape of the two disjoint areas and the shape of the two other disjoint areas are selected from the group consisting of circular, elliptic, triangular, rectangular, square, hexagonal, octagonal, and polygonal.

7. The device according to claims 1, wherein the loop antenna comprises a single turn having a shape selected from the group consisting of circular, elliptic, triangular, rectangular, square, hexagonal, octagonal, and polygonal.

8. The device according to claim 1, wherein the loop antenna comprises a plurality of concentric turns, each turn having a shape selected from the group consisting of circular, elliptic, triangular, rectangular, square, hexagonal, octagonal, and polygonal.

9. The device according to claim 1, further comprising
a set of terminals, and
a multiplexer coupled to selectively connect one of the first figure-eight antenna, the second figure-eight antenna, and the loop antenna to the set of terminals.

10. A method of manufacturing a planar RF transmitter antenna device, the method comprising
forming a first figure-eight antenna,
forming a second figure-eight antenna such that the second figure-eight antenna extends in a plane parallel to the plane of the first figure-eight antenna and such that the orientation of the second figure-eight antenna is perpendicular to the orientation of the first figure-eight antenna,
and forming a loop antenna in a plane parallel to the respective planes of the first figure-eight antenna and the second figure-eight antenna.
